(19) United States
(12) Patent Application Publication
(10) Pub. No.: US 2024/0260672 A1
(43) Pub. Date: Aug. 8, 2024

(54) POROUS CERAMIC ATOMIZATION CORE AND ELECTRONIC ATOMIZATION DEVICE USING SAME

(71) Applicant: SHENZHEN HUACHENGDA PRECISION INDUSTRY CO. LTD., Shenzhen (CN)

(72) Inventor: Ping CHEN, Shenzhen (CN)

(73) Assignee: SHENZHEN HUACHENGDA PRECISION INDUSTRY CO. LTD., Shenzhen, GD (CN)

(21) Appl. No.: 18/565,505

(22) PCT Filed: Sep. 8, 2021
(86) PCT No.: PCT/CN2021/117256

§ 371 Date: Nov. 29, 2023

(51) Int. Cl. A24F 40/48; A24F 40/10; A24F 40/44; A24F 40/46; H05B 3/14

(52) U.S. Cl. CPC A24F 40/48; A24F 40/10; A24F 40/44; A24F 40/46; H05B 3/141

(57) ABSTRACT

A porous ceramic liquid transfer unit comprises a ceramic body and a support portion extending downward from the ceramic body. The ceramic body comprises at least two protruding portions connected into a whole through a connecting portion. A liquid transfer channel is arranged in each of the protruding portions. The heating unit is attached to bottoms of the liquid transfer channels. An electronic atomization device comprises an atomizer housing. The porous ceramic atomization core is arranged in the atomizer housing. The support portion extends downward from the ceramic body to support the ceramic body, thus preventing the ceramic body from being fractured, and condensate formed on the support portion can be absorbed to be recycled; and multiple protruding portions are arranged on the ceramic body, and the liquid transfer channels are arranged in the protruding portions to feed liquid quickly to improve the liquid transfer efficiency, thus optimizing the atomization effect.

### FIELD

The invention relates to the technical field of atomization, in particular to a porous ceramic atomization core and an electronic atomization device using the same.

### BACKGROUND

Porous ceramic, as a mainstream liquid transfer material of atomization cores of existing atomization assemblies in this field, is widely used because of its advantages of good structural strength, uniform temperature of micro-pore structures, and high-temperature resistance. Porous ceramic atomization cores usually comprise a heating assembly and a porous ceramic liquid transfer assembly. In use, the heating assembly generates heat, the porous ceramic liquid transfer assembly atomizes liquid under high temperature of the heating assembly to generate a certain amount of gas, and when users inhale, an airflow will be generated to drive the gas to flow out, thus realizing a smoking effect.

However, existing porous ceramic atomization cores have the following defects: most existing porous ceramic atomization cores are provided with a porous ceramic body formed with one liquid transfer channel, a heating assembly is attached to the bottom of the porous ceramic body, and atomizing liquid is fed and transferred by means of one liquid transfer channel, so the liquid transfer rate is low, compromising the atomization effect of the porous atomization core. Since the heating assembly generally has a high temperature, cracks are probably formed in the contact surface between porous ceramic and the heating assembly, thus affecting the use of the porous ceramic atomization core. In addition, the atomized steam may encounter cold air at an air inlet (i.e., below the porous ceramic atomization core) to form condensate, leading to a waste of atomizing liquid and probably causing damage to electronic elements.

### SUMMARY

The technical issue to be settled by the invention is to overcome the defects in the prior art by providing a porous ceramic atomization core and an electronic atomization device using the same. Multiple protruding portions with liquid feeding and transfer channels are arranged, and liquid can be fed and transferred all over porous ceramic to increase the liquid feed and transfer rate of the porous ceramic, thus optimizing the atomization effect; and a support portion is arranged to support a ceramic body and recycle condensate.

The technical solution adopted by the present invention to solve the technical issue is to provide a porous ceramic atomization core which comprises a heating unit and a porous ceramic liquid transfer unit. The porous ceramic liquid transfer unit comprises a ceramic body and a support portion extending downward from the ceramic body. The ceramic body comprises at least two protruding portions which are connected into a whole through a connecting portion. A liquid transfer channel is arranged in each of the protruding portions, and the heating unit is attached to bottoms of the liquid transfer channels.

Preferably, in said porous ceramic atomization core, a notch is formed in a side face of the connecting portion or/and surfaces of side walls of the protruding portions to form an air passage.

Preferably, in said porous ceramic atomization core, the connecting portion is configured as a slope structure which inclines from one of the protruding portions to the other of the protruding portions; or, the connecting portion is configured as a ridge structure; or, the connecting portion is configured as an umbrella-shaped structure.

Preferably, in said porous ceramic atomization core, a convex rim extends outward from a top surface of each of the protrusion portions.

Preferably, in said porous ceramic atomization core, the support portion is configured as a hollow structure, a solid structure, or a cylindrical structure with a closed lower end.

Preferably, in said porous ceramic atomization core, grooves are formed in an outer surface of the support portion, or holes are formed in a side wall of the support portion, or the outer surface of the support portion is configured as an uneven coarse structure.

Preferably, in said porous ceramic atomization core, grooves are formed in an outer surface of the ceramic body, or holes are formed in a side wall of the ceramic body, or the outer surface of the ceramic body is configured as an uneven coarse structure.

Preferably, in said porous ceramic atomization core, the heating unit comprises a heating wire arranged in a middle thereof and electrodes arranged at two ends of the heating wire.

An electronic atomization device comprises an atomizer housing. The porous ceramic atomization core described above is arranged in the atomizer housing, top and bottom of the porous ceramic atomization core are clamped by a sealing element and a base respectively, and a liquid chamber is arranged between the atomizer housing and the porous ceramic atomization core.

Preferably, in said electronic atomization device, the sealing element is provided with a socket, and the porous ceramic atomization core is inlaid and fixed in the socket.

Preferably, in said electronic atomization device, the sealing element is provided with liquid transfer ports communicated with the liquid transfer channels and an air vent communicated with the air passage.

Preferably, in said electronic atomization device, the base is provided with a receiving cavity, the porous ceramic atomization core is arranged in the receiving cavity of the base, and the base is provided with an air inlet.

Preferably, in said electronic atomization device, an air inlet of the base is correspondingly communicated with the notch of the porous ceramic atomization core.

Preferably, in said electronic atomization device, a convex rim extends outward from a top surface of the porous ceramic atomization core, and all portions, other than the convex rim, of the porous ceramic atomization core are received in a receiving cavity of the base, and the convex rim abuts against a top surface of a side wall of the base.

Preferably, in said electronic atomization device, the porous ceramic atomization core is entirely received in a receiving cavity of the base.

The invention has the following beneficial effects: according to the porous ceramic atomization core and an electronic atomization device using the same, at least two protruding portions are arranged on a ceramic body and are connected into a whole through a connecting portion, a liquid transfer channel is arranged in each protruding portion, and a heating unit is attached to bottoms of the liquid transfer channels, such that multiple liquid inlets and liquid transfer channels are formed in the porous ceramic atomization core to feed liquid quickly to improve the liquid transfer efficiency, thus optimizing the atomization effect. A support portion extends downward from the ceramic body to support the ceramic body, thus preventing the ceramic body from being fractured; and condensate formed on the support portion can be absorbed to be recycled and prevented being inhaled by users, so the smoking experience will not be affected.

### BRIEF DESCRIPTION OF THE DRAWINGS

The invention will be further described below in conjunction with accompanying drawings and embodiments. In the drawings:

FIG. 1 is a three-dimensional front structural view according to a first implementation of a porous ceramic atomization core in Embodiment 1 of the invention;

FIG. 2 is a three-dimensional side structural view according to the first implementation of the porous ceramic atomization core in Embodiment 1 of the invention;

FIG. 3 is a three-dimensional front structural view according to a second implementation of the porous ceramic atomization core in Embodiment 1 of the invention;

FIG. 4 is an exploded view of an electronic atomization device in Embodiment 2 of the invention;

FIG. 5 is a sectional view of the electronic atomization device in Embodiment 2 of the invention;

FIG. 6 is a partial sectional view of the electronic atomization device in Embodiment 2 of the invention;

FIG. 7 is an assembled structural view of a porous ceramic atomization core and a base in Embodiment 2 of the invention;

FIG. 8 is a schematic structural view of a sealing element in Embodiment 2 of the invention; and

FIG. 9 is a schematic structural view of the base in Embodiment 2 of the invention.

### DESCRIPTION OF THE EMBODIMENTS

To gain a better understanding of the technical features, objectives and effects of the invention, specific implementations of the invention will be described in detail with reference to the accompanying drawings.

When one element is referred to as being “fixed to” or “arranged on” the other element, it may be directly or indirectly located on the other element. When one element is referred to as being “connected to” the other element, it may be directly or indirectly connected to the other element.

Terms such as “upper”, “lower”, “left”, “right”, “front”, “back”, “vertical”, “horizontal”, “top”, “bottom”, “inner” and “outer” are used to indicate directions or positions based on the accompanying drawings merely for the purpose of facilitating the description, and should not be construed as limitations of the technical solutions of the invention. Terms such as “first” and “second” are merely for the purpose description, and should not be construed as indicating or implying relative importance or implicitly indicating the number of technical features referred to. Unless otherwise expressly defined, “multiple” means two or more.

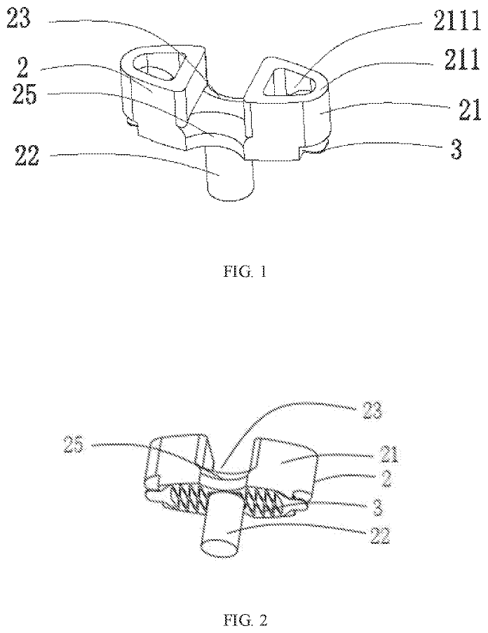

Embodiment 1: As shown in FIGS. 1-3, a porous ceramic atomization core 20 comprises a heating unit 3 and a porous ceramic liquid transfer unit 2. The porous ceramic liquid transfer body 2 comprises a ceramic body 21 and a support portion 22 extending downward from the ceramic body 2. The ceramic body 21 comprises at least two protruding portions 211, the number of the protruding portions 211 is not specifically limited and may be set as actually needed, preferably 2-4, the protruding portions 211 may be arranged in a linear shape, a triangular shape or a quadrilateral shape, the protruding portions 211 are connected into a whole through a connecting portion 23. A liquid transfer channel 2111 is arranged in each protruding portion 211, and the heating unit 3 is attached to bottoms of the liquid transfer channels 2111. Since multiple protruding portions 211 are arranged on the porous ceramic atomization core 20, that is, the porous ceramic atomization core 20 has multiple liquid inlets and liquid transfer channels 2111, liquid can be fed quickly by means of porous ceramic and the liquid transfer efficiency is improved, thus optimizing the atomization effect. The support portion 22 extends from a bottom surface of the ceramic body 21 to support the porous ceramic body 21, thus preventing the ceramic body 21 from being fractured. The support portion 22 is made from porous ceramic and can absorb condensate formed thereon, thus recycling the condensate. When the porous ceramic atomization core 20 works, atomizing liquid enters the multiple protruding portions 211 and is quickly transferred to the bottoms, in contact with the heating unit 3, of the liquid transfer channels 2111 arranged in the protruding portions 211, the heating unit 3 generates heat to atomize the atomizing liquid to form atomized steam, at the same time, the support portion 22 absorbs condensate formed thereon, and the condensate is atomized again by the heating unit 3 to form atomized steam.

A notch 25 is formed in a side face of the connecting portion 23 to form an air passage or/and notches 25 are formed in surfaces of side walls of the protruding portions 211 to form air passages. One or two notches 25 may be arranged, that is, one or two air passages may be formed. The size and shape of the notch 25 are not limited. In addition to the notch 25 formed in the side face of the connecting portion 23 or/and the notches 25 formed in the surfaces of the side walls of the protruding portions 211, the notch may also be formed due to the difference in shape between the side face of the connecting portion 23 and an inner wall of a base or/and the notches may also be formed due to the difference between the side walls of the protruding portions 211 and the inner wall of the base; or, a reflux hole penetrates through the connecting portion 23 to form an air passage, and the size and shape of the reflux hole are not limited. Atomized steam is mixed with air in the air passage to form aerosol, which is eventually inhaled by users.

The connecting portion 23 may be of various shapes. The ceramic body 21 comprises two protruding portions 211, the connecting portion 23 is configured as a slope structure inclining from one protruding portion 211 to the other protruding portion 211, or the connecting portion 23 is configured as a ridge structure formed by two slopes which gather together to the centre. Alternatively, the ceramic body 21 comprises multiple protruding portions 211, the connecting portion 23 is configured as an umbrella-shaped structure, and the multiple protruding portions 211 are connected by means of the umbrella-shaped connecting portion 23. The heating unit 3 generates heat to atomize atomizing liquid into atomized steam, and the atomized steam flows upwards and will turn into condensate when encountering cold air. Since the air passage is located near the connecting portion 23 and air will pass through the air passage, condensate is easily formed in the vicinity of the connecting portion 23, and when the condensate is accumulated to a certain extent, the atomizing liquid will not be sufficiently used, leading to a waste of the atomizing liquid; and the condensate may drip downward, leading to damage to electronic elements. By designing the connecting portion 23 into the slope structure which inclines from one protruding portion 211 toward the other protruding portion 211, condensate can flow from the protruding portion 211 on one side to the protruding portion 211 on the other side to be collected into the liquid transfer channel 2111 of the protruding portion 211 on the other side, thus recycling the condensate. Or, by designing the connecting portion 23 into the ridge structure or the umbrella-shaped structure, the condensate is unlikely to be accumulated and can directly flow to the bottom of porous ceramic body along the slopes of the ridge structure or the slopes of the umbrella-shaped structure to be heated and atomized again by the heating unit 3.

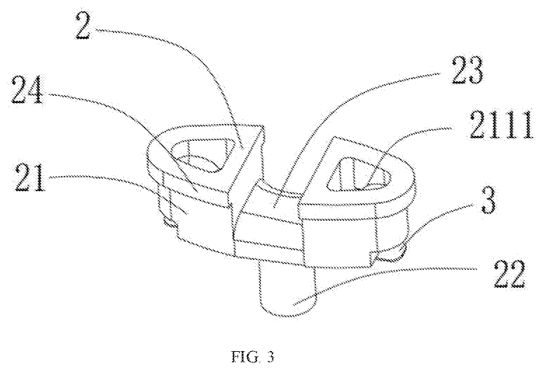

As shown in FIG. 3, a convex rim 24 extends outward from a top surface of each protruding portion 211 of the porous ceramic liquid transfer unit 2. When the porous ceramic atomization core is assembled, all portions, other than the convex rims 24 on the top surfaces of the protruding portions 211, of the porous ceramic liquid transfer unit 2 are received in the base, and bottom surfaces of the convex rims 24 abut against a top surface of a side wall of the base, such that the porous ceramic liquid transfer unit 2 has a better sealing effect. In addition, the convex rims 24 can be used as force application points to facilitate maintenance, assembly and disassembly.

The support portion 22 may be of different shapes and structures. The support portion 22 may be configured as a hollow structure, in this case, a hole is formed in a corresponding position of the connecting portion 23 to form an air passage. Completely atomized steam is mixed with air in the air passage to form aerosol which will be eventually inhaled by users, and atomizing liquid that is not completely atomized and mixed in atomized gas will turn into condensate when encountering cold air in the air passage; since the support portion 22 is made from porous ceramic, the condensate can be absorbed by the inner wall of the support portion 22 and transferred to the bottom of the ceramic body 21 to be atomized again. Or, the support portion 22 may be configured as a solid structure, such that the support 22 has better structural strength and can better support the ceramic body 21 and prevent the ceramic body 21 from being fractured. Or, the support portion 22 is configured as a cylindrical structure with a closed lower end, in this case, a cavity is formed in the support portion 22, condensate absorbed by the outer wall of the support portion 22 can be stored in the cavity, and the condensate in the cavity is then transported to the ceramic body 21, such that the condensate can be better absorbed and recycled.

Grooves are formed in an outer surface of the support portion 22, or holes are formed in a side wall of the support portion 22, or the outer surface of the support portion 22 is configured as an uneven coarse structure. In this way, the surface area of the support portion 22 (i.e., the contact area between the support portion 22 and condensate) is enlarged, thus bettering the condensate.

Grooves are formed in an outer surface of the ceramic body 21, or holes are formed in a side wall of the ceramic body 21, or the outer surface of the ceramic body 21 is configured as an uneven coarse structure. In this way, the surface area of the ceramic body 21 is enlarged. Condensate is probability formed where air passes, that is, condensate is probability formed on the outer surface of the ceramic body 21. The contact area between the outer surface of the ceramic body 21 and condensate is added, thus better recycling the condensate and avoiding a waste of atomizing liquid.

The heating unit 3 comprises a heating wire in the middle and electrodes at two ends of the heating wire. The heating unit 3 may be a metal heating sheet, and the heating wire of the heating unit 3 is attached to the bottom of the ceramic body 21. The heating unit 3 is generally made from an alloy with a high electrical resistivity such as a stainless steel alloy, a nickel-chromium alloy, a ferrum-chromium-aluminum alloy, or a ferrum-nickel alloy. The thickness of the heating body 3 may be 0.03 mm-0.2 mm, and the specific thickness of the heating unit 3 is not limited. The heating wire and the electrodes may be formed by a cutting or corrosion process, and the electrodes are in contact with external electrodes.

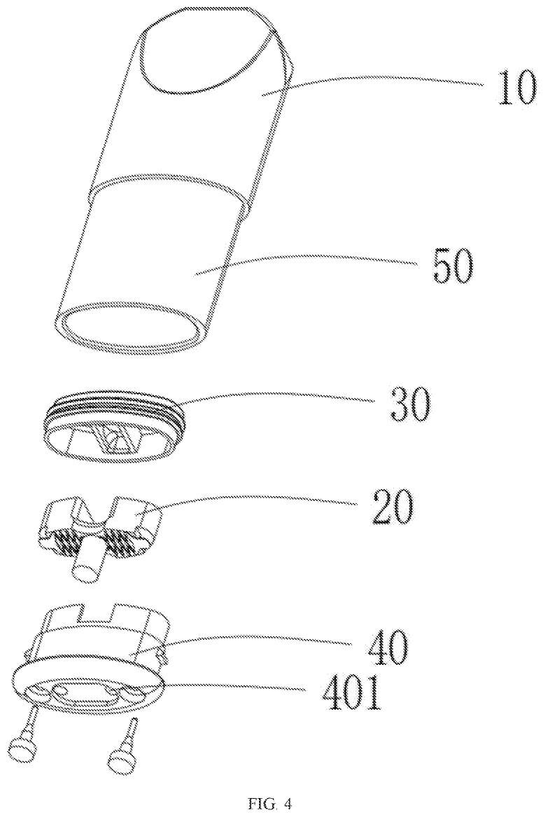

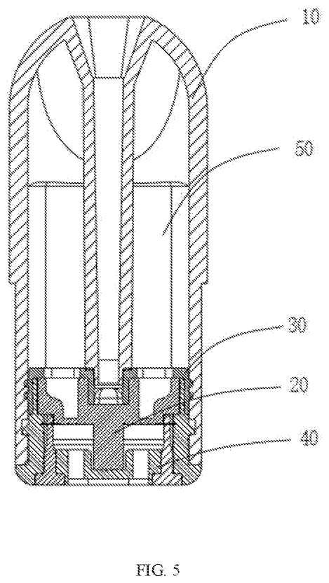

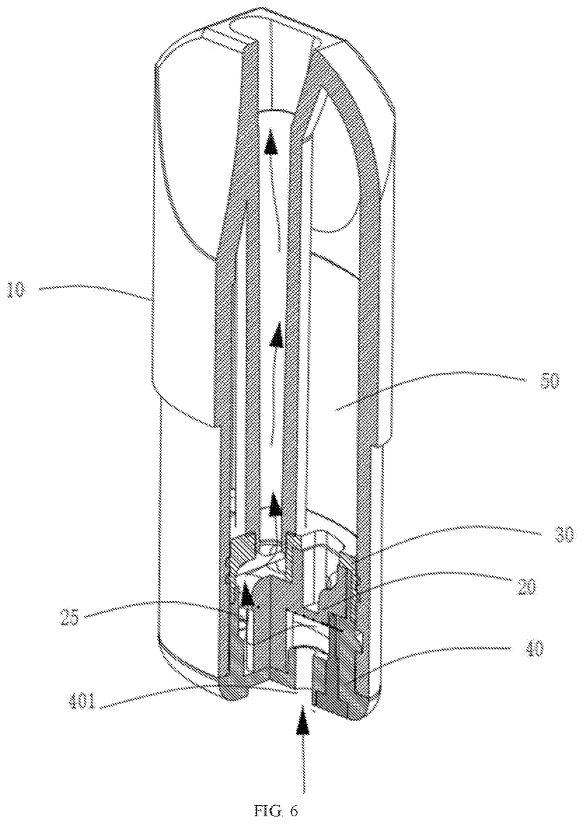

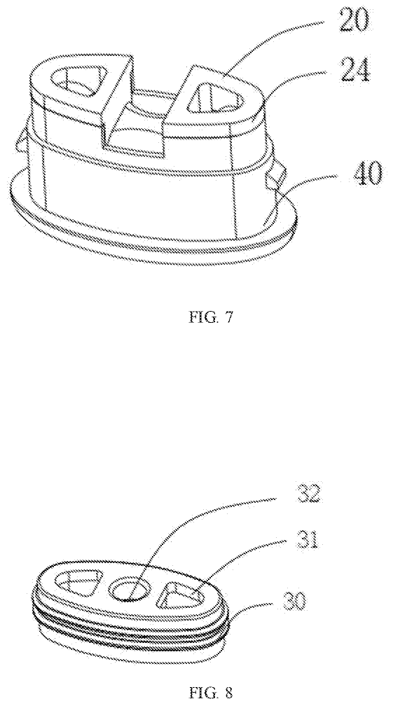

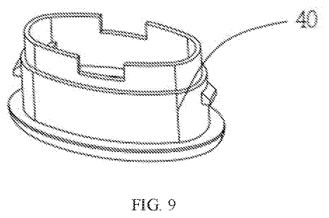

Embodiment 2: As shown in FIGS. 4-9, an electronic atomization device comprises an atomizer housing 10, wherein the porous ceramic atomization core 20 in Embodiment 1 is arranged in the atomizer housing 10, the top and bottom of the porous ceramic atomization core 20 are clamped by a sealing element 30 and a base 40 respectively, and a liquid chamber 50 is arranged between the atomizer housing 10 and the porous ceramic atomization core 20. The sealing element 30 is provided with a socket, the porous ceramic atomization core 20 is inlaid in the socket to be fixed, and liquid transfer ports 31 communicated with the liquid transfer channels 2111 and an air vent 32 communicated with the air passage are formed in the sealing element 30. The base 40 is provided with a receiving cavity, the porous ceramic atomization core 20 is arranged in the receiving cavity of the base 40, an air inlet 401 is formed in the base 40 and is correspondingly communicated with the notch 25 of the porous ceramic atomization core (20) to form an air passage. By means of the design of the sealing element 30 and the base 40, the atomization core is easy and convenient to assemble and high in reliability. When the electronic atomization device works, liquid in the liquid chamber enters the liquid transfer channels 2111 of the porous ceramic atomization core 20 via the liquid transfer ports 31 of the sealing element 30, air enters the porous ceramic atomization core 20 via the air inlet 401 of the base 40, the heating unit 3 of the porous ceramic atomization core 20 heats and atomizes the liquid into atomized steam, the atomized steam is mixed with the air entering the porous ceramic atomization core 20 via the air inlet 401 to form aerosol, and the aerosol flows out via the air vent 32 of the sealing element 30 to be inhaled by users eventually.

As shown in FIG. 7, a convex rim 24 extends outward from a top surface of each protruding portion 211 of the porous ceramic atomization core 20, all portions, other than the convex rims 24, of the porous ceramic atomization core 20 are received in the receiving cavity of the base 40, and the convex rims 24 abut against a top surface of a side wall of the base 40, such that the porous ceramic atomization core has a better sealing effect. Because it is difficult to accurately control the size tolerance of the porous ceramic due to the limitation of the production process of the porous ceramic, a large void space exits between the porous ceramic atomization core 20 and the base 40 after the porous ceramic atomization core 20 is assembled in the base 40. By arranging the convex rims 24 on the top surface of the porous atomization core, the top surface of the porous atomization core is higher than the top surface of the base 40, such that the space between the base 40 and the porous ceramic atomization core 20 is sealed by the sealing element 30. When the air pressure in the electronic atomization device becomes low with the consumption of liquid, air can eject sealing silicon open under pressure to enter the liquid chamber, thus realizing a ventilation effect.

The porous ceramic atomization core 20 is slightly smaller than the receiving cavity of the base 40 and thus can be entirely received in the receiving cavity of the base 40, and the sealing element 30 seals the base 40, such that the porous ceramic atomization core 20 is also sealed, and liquid leakage of the porous ceramic atomization core 20 is prevented.

1. A porous ceramic atomization core, characterized by comprising a heating unit (3) and a porous ceramic liquid transfer unit (2), wherein the porous ceramic liquid transfer unit (2) comprises a ceramic body (21) and a support portion (22) extending downward from the ceramic body (21), the ceramic body (21) comprises at least two protruding portions (211) which are connected into a whole through a connecting portion (23), a liquid transfer channel (2111) is arranged in each of the protruding portions (211), and the heating unit (3) is attached to bottoms of the liquid transfer channels (2111).

2. The porous ceramic atomization core according to claim 1, wherein a notch (25) is formed in a side face of the connecting portion or/and surfaces of side walls of the protruding portions (211) to form an air passage.

3. The porous ceramic atomization core according to claim 1, characterized in that the connecting portion (23) is configured as a slope structure which inclines from one of the protruding portions (211) to the other of the protruding portions (211); or, the connecting portion (23) is configured as a ridge structure; or, the connecting portion (23) is configured as an umbrella-shaped structure.

4. The porous ceramic atomization core according to claim 1, characterized in that a convex rim (24) extends outward from a top surface of each of the protrusion portions (211).

5. The porous ceramic atomization core according to claim 1, characterized in that the support portion (22) is configured as a hollow structure, a solid structure, or a cylindrical structure with a closed lower end.

6. The porous ceramic atomization core according to claim 1, characterized in that grooves are formed in an outer surface of the support portion (22), or holes are formed in a side wall of the support portion (22), or the outer surface of the support portion (22) is configured as an uneven coarse structure.

7. The porous ceramic atomization core according to claim 1, characterized in that grooves are formed in an outer surface of the ceramic body (21), or holes are formed in a side wall of the ceramic body (21), or the outer surface of the ceramic body (21) is configured as an uneven coarse structure.

8. The porous ceramic atomization core according to claim 1, characterized in that the heating unit (3) comprises a heating wire arranged in a middle thereof and electrodes arranged at two ends of the heating wire.

9. An electronic atomization device, characterized by comprising an atomizer housing (10), wherein the porous ceramic atomization core (20) according to claim 1 is arranged in the atomizer housing (10), top and bottom of the porous ceramic atomization core (20) are clamped by a sealing element (30) and a base (40) respectively, and a liquid chamber (50) is arranged between the atomizer housing (10) and the porous ceramic atomization core (20).

10. The electronic atomization device according to claim 9, characterized in that the sealing element (30) is provided with a socket, and the porous ceramic atomization core (20) is inlaid and fixed in the socket.

11. The electronic atomization device according to claim 9, characterized in that liquid transfer ports (31) communicated with the liquid transfer channels (2111) and an air vent (32) communicated with the air passage are formed in the sealing element (30).

12. The electronic atomization device according to claim 9, characterized in that the base (40) is provided with a receiving cavity, the porous ceramic atomization core (20) is arranged in the receiving cavity of the base (40), and the base (40) is provided with an air inlet (401).

13. The electronic atomization device according to claim 9, characterized in that an air inlet (401) of the base (40) is correspondingly communicated with the notch (25) of the porous ceramic atomization core (20).

14. The electronic atomization device according to claim 9, characterized in that a convex rim (24) extends outward from a top surface of the porous ceramic atomization core (20), and all portions, other than the convex rim (24), of the porous ceramic atomization core (20) are received in a receiving cavity of the base (40), and the convex rim (24) abuts against a top surface of a side wall of the base (40).

15. The electronic atomization device according to claim 9, characterized in that the porous ceramic atomization core (20) is entirely received in a receiving cavity of the base (40).

16. The porous ceramic atomization core according to claim 9, wherein a notch (25) is formed in a side face of the connecting portion or/and surfaces of side walls of the protruding portions (211) to form an air passage.

17. The porous ceramic atomization core according to claim 9, characterized in that the connecting portion (23) is configured as a slope structure which inclines from one of the protruding portions (211) to the other of the protruding portions (211); or, the connecting portion (23) is configured as a ridge structure; or, the connecting portion (23) is configured as an umbrella-shaped structure.

18. The porous ceramic atomization core according to claim 9, characterized in that a convex rim (24) extends outward from a top surface of each of the protrusion portions (211).

19. The porous ceramic atomization core according to claim 9, characterized in that the support portion (22) is configured as a hollow structure, a solid structure, or a cylindrical structure with a closed lower end.

20. The porous ceramic atomization core according to claim 9, characterized in that grooves are formed in an outer surface of the support portion (22), or holes are formed in a side wall of the support portion (22), or the outer surface of the support portion (22) is configured as an uneven coarse structure, or/and
grooves are formed in an outer surface of the ceramic body (21), or holes are formed in a side wall of the ceramic body (21), or the outer surface of the ceramic body (21) is configured as an uneven coarse structure.
